(19) United States
(12) Patent Application Publication
(10) Pub. No.: US 2016/0253449 A1
(43) Pub. Date: Sep. 1, 2016

(54) THREE DIMENSIONAL (3D) VIRTUAL IMAGE MODELING METHOD FOR OBJECT PRODUCED THROUGH SEMICONDUCTOR MANUFACTURING PROCESS

(71) Applicant: Daouincube, Inc., Yongin-si (KR)

(72) Inventors: Tae Hwa LIM, Yongin-si (KR); Dong Wan KANG, Gwanak-gu (KR); Hyun Cheol KIM, Seongnam-si (KR)

(73) Assignee: Daouincube, Inc., Yongin-si (KR)

(21) Appl. No.: 15/052,372

(22) Filed: Feb. 24, 2016

(30) Foreign Application Priority Data
Feb. 27, 2015 (KR) 10-2015-0028382

(51) Int. Cl. G06F 17/50

(52) U.S. Cl. CPC G06F 17/5081

(57) ABSTRACT

A three dimensional (3D) virtual shape modeling method for an object produced through a semiconductor process is provided, which can model a 3D shape of an object produced through processes such as deposition, etching, and so on that are used in a semiconductor or planar display panel manufacturing process. Specifically, convenient modeling can be performed when forming a layer produced through deposition and then etching on a non-flat, preceding layer, by using two dimensional projection method.

### CROSS-REFERENCE TO RELATED APPLICATIONS

This application claims the benefit of priority to Korean Application No. 10-2015-0028382, filed Feb. 27, 2015, in the Korean Intellectual Property Office. All disclosures of the document named above is incorporated herein by reference.

### BACKGROUND OF THE INVENTION

1. Field of the Invention

The present disclosure relates to a three dimensional (3D) virtual image modeling method for an object produced through a semiconductor or a planar display panel manufacturing process, and more particularly, to a 3D virtual image modeling method which automatically generates a 3D structure by using sequences in which deposition/etching are performed, and mask data.

2. Description of the Related Art

Simulation or modeling performed during a product development process prior to actual development of products has been continuously researched and developed as a way to reduce errors and save overall expenses, and accompanied with advancing computer system technology, it has been provided with remarkable enhancement as a modeling method using computing programs. For example, AutoCAD or Solidworks are examples of commercial products that utilize 3D modeling method. These indeed provide resultant products with such a high level of quality that they are widely used in manufacturing sites.

However, situations are somewhat different when designing products in a semiconductor or TFT display manufacturing process. This process actually involves repeated deposition and etching, in which shape is determined based on a mask basically, but then thickness and angles of inclinations are finally determined according to characteristics of materials and time of exposure.

A conventional method of designing an object produced through a semiconductor or display manufacturing process involves generating a 3D structure by using plane shape (2D data) of a mask, and then adding depth information to the 2D CAD drawing.

However, since the processes are performed such that respective 3D structures are accumulated, stacking is not possible with a method of adding depth to the 2D mask plane. In other words, the process requires an operation of modifying 3D structure of a next layer stacked above, according to the shape of an underlying surface, and matching of respective adjacent surfaces is then necessary for the meshing operation for 3D simulation. Conventionally, an operator can directly edit when shapes are simple, but as semiconductor integration and complexity is accelerated, patterns, and deposition/etching processes become more complicated to the extent that it is not possible to perform 3D modeling with the conventional method anymore.

Meanwhile, in order to automate modeling of objects produced through a semiconductor or display manufacturing process. Boolean engine and so on, can be used, but it takes lengthy time due to high complexity, and also in view of matching, errors related with floating points or inclined surfaces are highly likely to occur.

### SUMMARY OF THE INVENTION

### Technical Problem

An object of the present disclosure is to solve the problems mentioned above, and accordingly, it is an object of the present disclosure to provide a 3D virtual shape modeling method for an object produced from a semiconductor or planar display panel manufacturing process, which automatically generates a 3D structure by using sequences in which deposition/etching are performed, and mask data.

### Solution to Problem

According to the present disclosure, a three dimensional (3D) virtual image modeling method for an object produced through a semiconductor process is provided, which may include generating a planar projection diagram of an n-th layer based on a mask shape for the n-th layer to be stacked on an existent m-th layer, segmenting the projection diagram according to a shape of the m-th layer, by performing Boolean operation between the projection diagram and the m-th layer, and completing a virtual shape of the n-th layer which is 3D shape by applying a bend to the projection diagram according to the shape of the m-th layer, and expanding to a height of the n-th layer.

The generating the projection diagram may include generating a shape of a bottom surface of the n-th layer according to the mask shape for the n-th layer, generating a virtual shape of a top surface by applying Boolean engine based on the shape of the bottom surface, and generating a side surface of the n-th layer by connecting nodes corresponding to the bottom surface and the top surface.

The completing the virtual shape is completed as respective portions segmented on the bottom surface are moved in a z-axis direction according to height information of the top surface of the m-th layer and disposed, and as respective portions segmented on the top surface are disposed at a position corresponding to a position of the bottom surface added with a height of the n-th layer.

### Advantageous Effects of Invention

A 3D modeling method according to the present disclosure has a reduced complexity as it uses projection technique to process modeling of a shape of a layer to be newly generated on an existent layer with a two dimensional computation, and additionally, shortened processing time can be anticipated.

### BRIEF DESCRIPTION OF THE DRAWINGS

FIG. 1 is a flowchart provided to explain a 3D modeling method according to an exemplary embodiment;

FIG. 2 is a flowchart provided to explain operation at S105 of FIG. 1;

FIG. 3 is a view exemplifying a model formed by 3D modeling;

FIG. 4 is a view provided to explain a method for modeling the third layer of FIG. 3; and

FIG. 5 is a view provided to explain a method for generating a projection diagram of the third layer of FIG. 3.

### DETAILED DESCRIPTION OF THE EMBODIMENTS

Hereinbelow, exemplary embodiments of the present disclosure will be described in detail with reference to accompanying drawings.

A method according to an exemplary embodiment is performed, for example, on a computer apparatus that performs 3D shape modeling of an object produced by a semiconductor process, so that a virtual 3D shape as a result of modeling is displayed through a display, and so on.

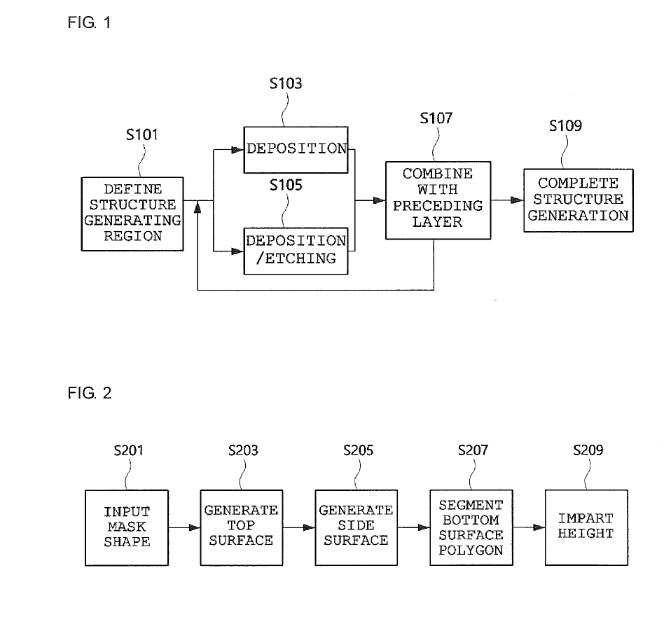

A 3D modeling method illustrated in FIG. 2 is applicable to any 3D modeling that basically utilizes a semiconductor process. For example, it is applicable to not only semiconductor chip designing, but also 3D modeling of a planar display panel fabricated with semiconductor process.

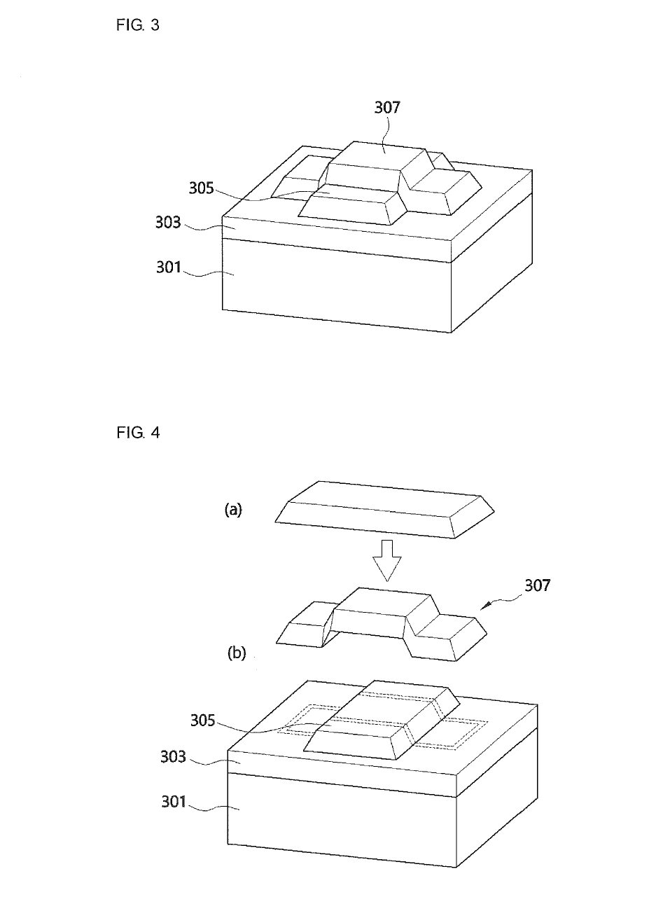

As noted above, a semiconductor process involves forming of a structure with deposition and etching processes, in which thickness and shape are determined according to the deposition/etching method and characteristics of a material. The process can be described as two processes of stacking generated layers, as below: (1) the first stacking of a layer formed by deposition process; and (2) another stacking of a layer formed by deposition and etching. For example, FIG. 3 illustrates a semiconductor in which first to third layers 303, 305, 307 are stacked on a substrate 301. The first layer 303 is formed on the substrate 301 by deposition, and the second and third layers 305, 307 are each formed by masking.

Meanwhile, a model element for use in modeling a structure in a 3D virtual space (simply, ‘space’) defined by X-Y-Z axes includes a node (or point), an edge (or side), a polygon, and a polyhedron. Using this combined information of the model element, 3D shape information is generated, and by performing rendering based on such information, a model that is visually observable by an operator is displayed through a display such as a computer, and so on.

The term ‘node’ as used herein refers to a position in the space, and the ‘edge’ is used as a constituent element of a polygon. One polygon may be defined with the node and edge information. The nodes and edges shared by the adjoining polygons are shared by each of such polygons. The ‘polyhedron’ refers to one single mass in the space formed of a plurality of polygons, and object information (name or index) is set for the polyhedron.

Hereinafter, a modeling method according to the present disclosure will be described with reference to FIG. 2.

### Determining Modeling Region: S101

A ‘bottom region’ of an object or structure as a subject of modeling is determined on X-Y plane. Through subsequent processes, a structure is stacked on the bottom region in z-axis direction.

### Layer by Deposition: S103

The first layer 303 of FIG. 3 is an example of a layer that is formed solely by the deposition. The layer is applied entirely on the bottom region or preceding layer. This step relates to first forming a polyhedron by imparting a vertical thickness to a specific polygon, after which combining with the bottom region or precious layer is followed, at S107. Accordingly, necessary data includes information of polygon to be used, information of layer's thickness, and object information of a corresponding layer.

The modeling completes a polyhedron by positioning a polygon on X-Y plane, parallel-copying by the thickness in Z-axis direction, and then generating a side surface based on the edges. All of the polyhedrons formed in this step are basic polyhedrons with flat bottom and top surfaces.

### Layer Formed by Deposition and Etching: S105

The layer such as the second layer 305 or the third layer 307 of FIG. 3 is a layer that is formed by deposition combined with etching. Referring to FIG. 4A, a basic polyhedron 307a is first formed, and then at S107, transformed to conform to the shape of the preceding layer and combined. Accordingly, this step involves forming a basic polyhedron by, (1) first, determining a thickness of a polyhedron applied in the deposition, and (2) then determining a shape determined by the etching by masking. Accordingly, necessary data includes object information, polygon information, layer thickness information, and mask information.

The mask information includes a mask shape, and a ‘mask-edge cross section information’. The mask shape may use graphic database system (GDS) format. The ‘mask-edge cross section information’ refers to information of a cross section at every edge of a shape formed by a mask. Due to limited technology, the cross section in the etching process has a certain slope rather than being vertically formed at the edge of the mask. Such slope may be determined by the hardness of the material, time of exposure, and so on. Accordingly, the mask-edge cross section information may be defined by whether a corresponding edge has a certain slope or is planar, whether the corresponding edge is a curved surface having a positive curvature (convex shape) or a negative curvature (concave shape), or depending on examples, a user-defined curve may be applied. An angle of slope is sufficient for a planar surface. The curvature information is necessary for a curve having one curvature, and node information and curvature of each curved surface will be necessary for an example where a plurality of curved surfaces are connected.

The process of forming a layer at S105 will be described again below, based on FIG. 2.

### Completing Modeling: S107, S109

The layer previously formed through S103 or S105 is combined on the bottom region determined at S101, and then at S107, the process of combining a new layer on a preceding layer is repeatedly performed, while operations at S103 and S105 are repeated.

The combining process at S107 varies depending on the shape of the preceding layer. For example, for the layer such as the first layer 303 or the second layer 305 that are combined with the flat substrate 301, the combining process involves simple overlaying. However, the second layer 305 on which the third layer 307 will be overlain is not flat, the basic polygon is segmented and combined. This process will be described with reference to FIG. 2 below.

When the process of stacking each layer of the semiconductor is completed by S103 to S107, at S109, an image is rendered by using final combining information so that a 3D model is completed and displayed, and the 3D modeling process is completed.

With the method described above, an operator does not have to manually complete each layer to complete a 3D modeling, because the operator simply can input necessary data.

Hereinafter, the process of forming a layer by deposition and etching in S105 to S107 will be described with reference to FIGS. 2 to 5. For convenience of explanation, the process of forming the third layer 307 of FIG. 3 will be described as an example. As described above, the second layer 305 and the third layer 307 are formed by performing deposition first, and then partial removal by etching. Note that, because the third layer 307 is stacked on the previously-formed second layer 305, the layers cannot be at the same height as a reference plane, but formed with a stepped portion according to the shape of the second layer 305.

The modeling process involves forming a basic polyhedron 307a having a masking shape such as the one illustrated in FIG. 4A, and then forming this into a final polyhedron 307 as the one illustrated in FIG. 4B according to the shape of a preceding layer. In this process, processing a 3D shape such as the basic polyhedron 307a of FIG. 4A will be very difficult and complicated. According to an exemplary embodiment, a projected form of a 3D polyhedron on a plane, i.e., a ‘projection diagram’ of a 3D polyhedron is created, and then this 2D projection diagram is segmented according to the shape of the preceding layer, and then a 3D layer shape is generated by applying height information of the preceding layer to the segmented projection diagram.

Accordingly, the modeling involves: (1) generating projection diagram of a basic polyhedron (S201 to S205); (2) segmenting projection diagram (S207); and (3) expanding in Z axis (S209). The operation (1) corresponds to S105, and operations (2) and (3) correspond to S107.

### Generating Projection Diagram of a Basic Polyhedron: S201 to S205

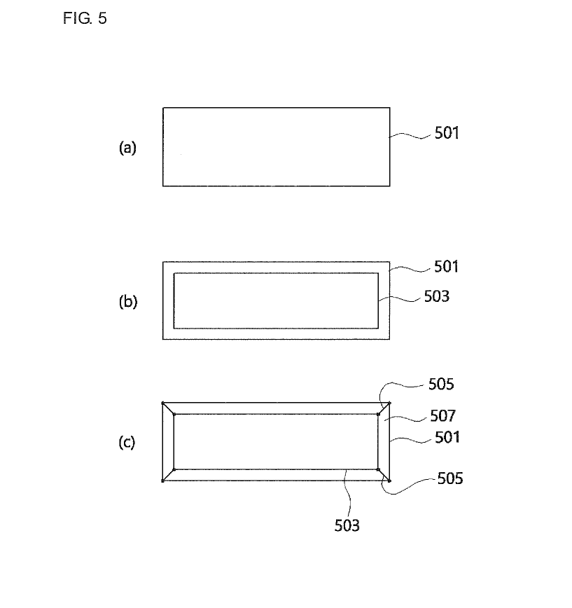

Generating projection diagram of a basic polyhedron includes, first, extracting a shape of a layer from the mask information, and generating a bottom surface 501 of the basic polyhedron 307a of FIG. 4 as illustrated in FIG. 5A. At S201, because it is before segmentation, the bottom surface 501 is a plane.

After computing the bottom surface 501, the top surface 503 is generated as illustrated in FIG. 5B. During etching, inclination is generated between the bottom surface 501 and the top surface 503, and the information of such inclined surface is extracted from the mask-edge cross section information. It is assumed herein that the inclined surface is a plane having a certain slope. Accordingly, if a portion where the inclined surface is projected vertically on the bottom surface 501 is called an inclined portion, it is assumed that the top surface 503 of the polyhedron is the region excluding the inclined portion from the bottom surface 501. Accordingly, the top surface 503 is a polygon having an edge size reduced by the 2D Boolean engine (or Boolean operation) by a distance in consideration of a thickness of the top surface 503, and a slope extracted from the mask-edge cross section information.

After the bottom surface 501 and the top surface 503 are generated through S201 and S203, nodes corresponding to the bottom surface 501 and the top surface 503 are paired with each other, and an edge 505 connecting these nodes is generated to thus generate a side surface 507. Accordingly, the projection diagram 510 is completed. Referring to FIG. 5C, the projection diagram 510 is defined as a polyhedron having the bottom surface 501, the top surface 503, and the side surface 507 all existing on a plane. This projection diagram 510 is the information of the polyhedron on a plane, i.e., before expansion in the z axis direction. Meanwhile, at S205, when two edges of the bottom surface 501 (or top surface 503) connected with each other are at an acute or obtuse angle rather than 90°, by the edge processing, the number of nodes may increase or decrease, in which case the connection between the top surface 503 and the bottom surface 501 may have 1:2 or 2:1 node connection so that the side surface 507 is in a triangular shape.

### Segmenting Projection Diagram of Basic Polyhedron: S207

Segmenting a projection diagram involves projecting the projection diagram 510 generated at S201 to S206 onto a previously stacked layer, i.e., onto the second layer 305 and segmenting the same. The Boolean engine is used when segmenting the projection diagram.

The Boolean engine is widely used in the computer graphic field, and it performs operations including merging at least one polygonal sets or segmenting the same. By performing operations such as AND, not, and so on between the projection diagram 510 and the preceding layer, the projection diagram 510 is segmented according to the shape of the preceding layer, and node information is added according to the segmentation.

### Completing Layer: S209

When the projection diagram segmented at S207 is completed, deposition process is reproduced in a manner such that 3D bend matching the preceding layer is applied to the bottom surface 501 by applying the height information applied to the preceding layer, and the top surface 503 is moved in the z axis by the height applied to the third layer 307 and positioned.

Through the process described above, layer modeling is performed as the layers are completed by deposition and etching.

As described above, the process of segmenting in a manner of projecting a plane image onto a space allows the overall computation to be simple. It is practically complicated to actually realize the computation that can establish a stack on a non-flat structure three dimensionally based on completed polyhedrons, and there also will be reduced stability.

The foregoing exemplary embodiments and advantages are merely exemplary and are not to be construed as limiting the exemplary embodiments. The present teaching can be readily applied to other types of apparatuses. Also, the description of the exemplary embodiments of the present inventive concept is intended to be illustrative, and not to limit the scope of the claims.

What is claimed is:

1. A three dimensional (3D) virtual image modeling method for an object produced through a semiconductor process, comprising:
generating a planar projection diagram of an n-th layer based on a mask shape for the n-th layer to be stacked on an existent m-th layer;
segmenting the projection diagram according to a shape of the m-th layer, by performing Boolean operation between the projection diagram and the m-th layer; and
completing a virtual shape of the n-th layer which is 3D shape by applying a bend to the projection diagram according to the shape of the m-th layer, and expanding to a height of the n-th layer.

2. The 3D virtual image modeling method of claim 1, wherein the generating the projection diagram comprises:
generating a shape of a bottom surface of the n-th layer according to the mask shape for the n-th layer;
generating a virtual shape of a top surface by applying Boolean engine based on the shape of the bottom surface; and
generating a side surface of the n-th layer by connecting nodes corresponding to the bottom surface and the top surface.

3. The 3D virtual image modeling method of claim 2, wherein in the completing the virtual shape, respective portions segmented on the bottom surface are moved in a z-axis direction to have a bend according to height information of the top surface of the m-th layer, and
respective portions segmented on the top surface are disposed at a position corresponding to a position of the bottom surface added with a height of the n-th layer.
